(19) United States
(12) Patent Application Publication
(10) Pub. No.: US 2013/0211610 A1
(43) Pub. Date: Aug. 15, 2013

(54) CONFIGURING OF A FIELD DEVICE IN AN ARRAGEMENT FOR DISTRIBUTION OF ELECTRIC ENERGY

(71) Applicants: Thomas Jachmann, Buffalo Grove, IL (US); Gunther ReichenbachH, Burgthann (DE); Norbert Schuster, Allersberg (DE)

(72) Inventors: Thomas Jachmann, Buffalo Grove, IL (US); Gunther ReichenbachH, Burgthann (DE); Norbert Schuster, Allersberg (DE)

(73) Assignee: SIEMENS AKTIENGESELLSCHAFT, MUENCHEN (DE)

(21) Appl. No.: 13/811,718

(22) PCT Filed: Jul. 23, 2010
(86) PCT No.: PCT/EP10/60731

§ 371 Date: Mar. 14, 2013

(51) Int. Cl. G05F 5/00

(52) U.S. Cl. CPC G05F 5/00
USPC 700/286

(57) ABSTRACT

A method configures an energy automation device and can be carried out more easily and more quickly and also with comparatively less susceptibility to errors. A system circuit diagram of a substation of an electrical power grid is generated by a configuration computer. The system circuit diagram is configured to be displayed by a display device of the configuration computer and contains component depictions that are graphic representations of primary devices of the substation. The system circuit diagram contains connections between the component depictions that are graphic representations of the electrical links between the primary devices. A selection of a sub-region of the system circuit diagram which is made by a user of the configuration computer is detected, and the selected sub-region of the circuit diagram is converted into a display configuration file suitable for a display device of the energy automation device.

The invention relates to a method for configuring an energy automation device and a configuration computer equipped for performing such a method.

Energy automation devices are used in systems for protecting, controlling, and monitoring electrical power grids. Examples of such devices may include electrical protective devices, station control devices, control devices, or measuring devices, such as so-called “remote terminal units”. During their operation, such energy automation devices run device software by means of a control device (for example, a microprocessor), which determines the functions of the respective energy automation device. In addition, various parameters can be set in the device software in order to adapt to the respective characteristics of the automated electrical power grid. The interaction between the device software and the respective parameters determines the behavior of the energy automation device during its operation.

Modern energy automation devices often also have user interfaces in the form of input means (usually pushbuttons) and display devices (usually in the form of LCD modules) via which on-site operation of the respective energy automation device can be performed. In such a case, specifying the operation of an energy automation device also includes adjusting the behavior and appearance of the user interfaces, in particular, display devices.

In addition, the display device of an energy automation device is usually required to display a section of the electrical power grid that is protected, controlled, or monitored by the respective energy automation device with respect to its topology (for example, in the form of a so-called single-line representation), for example, by depicting a substation feeder that is monitored by a protective device on the display of the protective device. In order to create such a display, the user of the respective energy automation device previously had to create the desired image manually, either directly through the on-site operation of the energy automation device in question, or by means of the configuration computer in a graphical editor, and transfer it to the energy automation device. Since the size and resolution of the display devices of energy automation devices is limited for cost reasons, and the graphical editors often allow creating the desired image only in a pixel-based form, generating such an image often proves to be difficult and tedious. Because the display depicted on the display device does not correspond completely to the actual section of the electrical power grid, such a manual process is also prone to errors, which can have a negative effect on the operation of the energy automation device in question.

The object of the invention is therefore to specify a method and a configuration computer for configuring an electrical energy automation device with respect to a representation of a section of the electrical power grid to be displayed on a display device of the energy automation device, with which the configuration can be performed more easily and quickly and is comparatively less susceptible to errors.

To achieve this object, a method for configuring an energy automation device is proposed, in which a system circuit diagram of a substation of an electrical power grid is generated by means of a configuration computer, wherein the system circuit diagram is designed to be displayed by a display device of the configuration computer and comprises component depictions that are graphical representations of primary devices of the substation, and wherein the system circuit diagram comprises connections between the component depictions that are graphical representations of electrical links between the primary devices. A selection of a portion of the system circuit diagram that is made by a user of the configuration computer is detected, and the selected portion of the system circuit diagram is converted into a display configuration file that is suitable for a display device of the energy automation device, by identifying the connections existing between the component depictions contained in the selected portion by means of the configuration computer and creating connection information that specifies the connections between these component depictions, and by associating simplified component depictions with the component depictions contained in the selected portion by means of the configuration computer, which are suitable for being displayed on the display device of the energy automation device. The corresponding simplified component depictions and the connection information are stored as a display configuration file in a storage device of the configuration computer.

A display configuration file for an energy automation device is created by means of the method according to the invention without special manual effort and is thus not very susceptible to errors. The user must merely specify the portion of a system circuit diagram that is to be displayed on the energy automation device, for example, by specifying a selection frame. The method according to the invention also takes into account the fact that a system circuit diagram on the display device of a configuration computer, which typically has a comparatively large monitor with high resolution and a color display, can be depicted differently than on a display device of an energy automation device, which, particularly for cost reasons, often has a comparatively small display with low resolution and a black/white or grayscale image. In order to take into account such technical constraints, a display configuration file is obtained from the system circuit diagram that is optimized for being displayed on the display device of the configuration computer, which enables a simplified depiction on a display device of the energy automation device.

One advantageous development of the method according to the invention provides that the display configuration file is stored by means of the configuration computer as part of a parameter set containing configuration parameters that are created by means of the configuration computer, which are used to determine the behavior of the energy automation device during its operation.

In this way, the display configuration file can be virtually used as an integral component of a parameter set to be created in any case within the scope of the configuration of the energy automation device.

It is also considered advantageous if the system circuit diagram is generated by means of the configuration computer using a system definition file, in particular, an SSD file in accordance with the IEC 61850 standard, which specifies a description of the topology of the substation of the electrical power grid.

The system circuit diagram thus does not have to be drawn manually, but can be created from the data stored in a system definition file in any case, for example, an SSD (system specification description) file according to the IEC 61850 standard specified for communication in substations and switching systems of electrical power grids, by converting the specifications contained in the system definition file as a description of the topology of the substation or switching system into a graphical representation in the form of a system circuit diagram (for example, as a single-line representation).

Another advantageous embodiment of the method according to the invention additionally provides that at least some of the component depictions contained in the system circuit diagram are associated with primary devices of the electrical power grid that can assume at least two different operating states, and state information is associated with the corresponding component depictions that specifies the respective primary device represented by the component depiction and the various possible operating states of the respective primary device.

In this context, it can be specifically provided that a simplified component depiction is created and entered into the display configuration file in order to create the display configuration file by means of the configuration computer with the aid of the state information for each possible state of the respective primary device that is associated with the component depictions.

A display configuration file can thus be created that allows the energy automation device to display different versions of the simplified component depiction (for example, an open or closed switch symbol) on its display device according to the state of the primary devices (for example, open or closed in the case of a switch) in the substation and therefore to describe the current state of the switching system accurately.

According to another advantageous embodiment, it can also be provided that the configuration computer comprises a library for associating the simplified component depictions with the component depictions, in which simplified component depictions are respectively associated with different types of component depictions, and the configuration computer identifies a type of the respective component depiction and takes the corresponding simplified component depiction from the library.

Here, a type of a component depiction means the type of a primary device (for example, power switch, circuit breaker, grounding switch, transducer, transformer) that the component depiction specifies. In this case, a simplified component depiction (for example, a symbol for a power switch or a current transformer) is associated with each type of a component depiction in a library of the configuration computer, so that it is possible to convert the system circuit diagram into the display configuration file by means of the configuration computer without any problem.

In addition, another advantageous embodiment of the method according to the invention provides that display device information is stored in the storage device of the configuration computer, which comprises specifications of at least one size and one resolution of the display device of the energy automation device, and the display configuration file is created by means of the configuration computer such that it is suitable for being displayed on the display device, taking into account the display device information.

Depending on the type of display device of the affected energy automation device, this makes it possible to create an adapted display configuration file that is optimized for being displayed on the display device in question with its technical characteristics.

In addition, it is specifically possible to provide that at least the size of the simplified component depictions and/or the spaces between the simplified component depictions are adjusted when creating the display configuration file, taking into account the display device information.

Finally, according to another advantageous embodiment of the method according to the invention, it is possible to provide that the display configuration file is transferred to the energy automation device and interpreted by a data processing device of the energy automation device such that the data processing device creates a graphical display on the display device of the energy automation device by means of the display configuration file that displays the simplified component depictions and the connections existing between them.

It is thus possible to use the display configuration file to specify the display on the energy automation device.

The aforementioned object is also achieved via a configuration computer having a data processing device, a storage device, and a display device, which is equipped to carry out a method as claimed in one of claims 1 to 9.

The invention is described in detail below with the aid of an embodiment, as shown in the following figures:

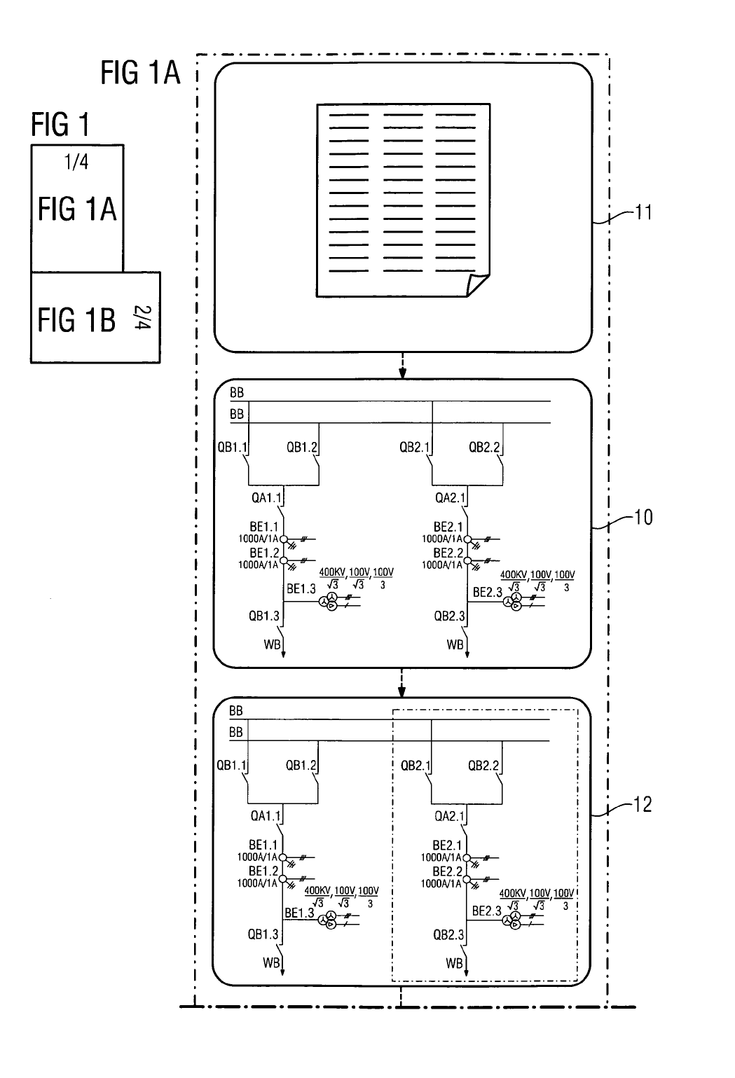

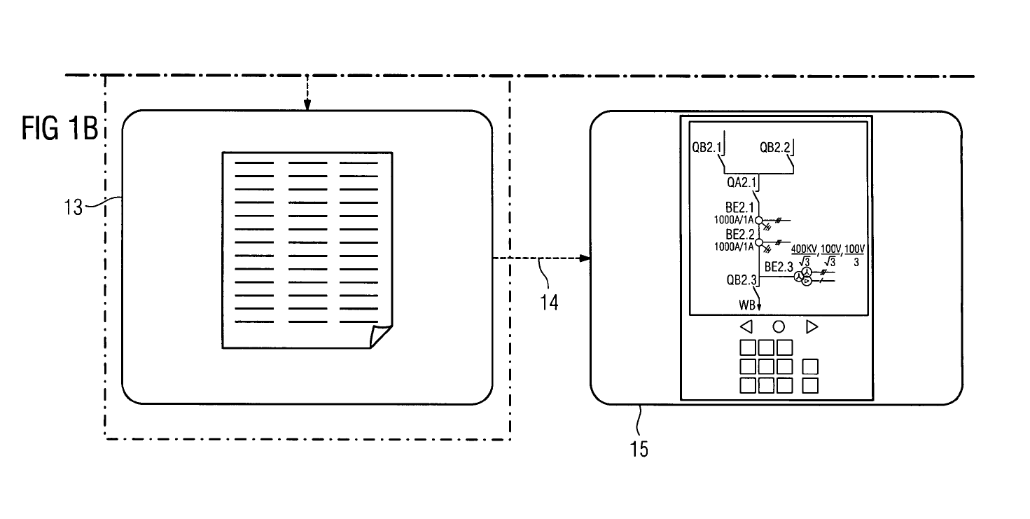

FIG. 1 A schematic flow diagram for explaining a method for configuring an energy automation device;

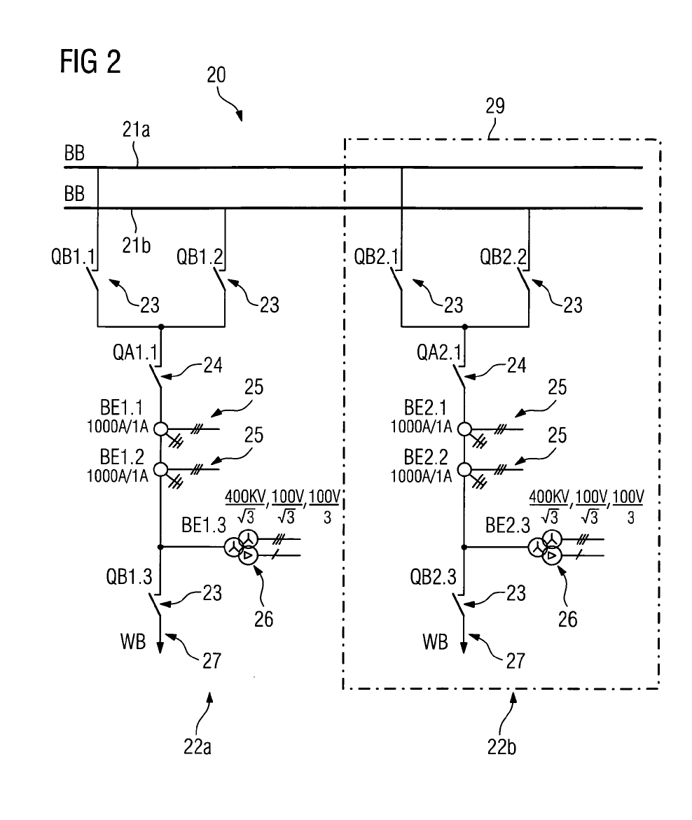

FIG. 2 An embodiment of a system circuit diagram;

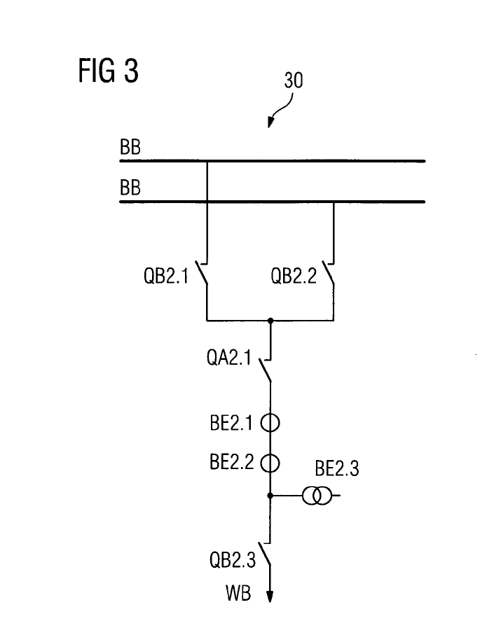

FIG. 3 An embodiment of a display on an energy automation device that is based on a display configuration file.

FIG. 1 shows a schematic flow diagram for explaining an embodiment of a method for configuring an energy automation device, specifically, for configuring an energy automation device having a display device (for example, a monitor) with respect to the display depicted on the display device. Energy automation devices, such as protective devices, station control devices, or measuring devices (RTUs) for energy automation systems are being shipped more and more frequently having designs that include display devices such as LCD displays. Users of such energy automation devices often want to use the display device to display elements of an electrical power grid graphically, such as a feeder (bay) of a switching station or substation of the power grid that is monitored by a protective device. It must be taken into account that, for cost reasons, the display devices of the energy automation devices usually have a comparatively small size and low resolution. Using the method described in FIG. 1 along with those described in FIGS. 2 and 3, it is possible to carry out such a configuration of an energy automation device with respect to the graphical display on its display device particularly easily, quickly, and without susceptibility to errors.

In a first step 10, a system circuit diagram of a substation of the electrical power grid is generated by means of a configuration computer, which can be a PC or a laptop, on which configuration software runs (for example, the DIGSI configuration software from Siemens AG). Such a system circuit diagram is usually depicted in the manner also known as the “single-line representation”. The primary devices (for example, busbars, power switches, circuit breakers, transformers, grounding switches, current transformers, voltage transformers) belonging to a system (for example, a substation or switching station) of an electrical power grid are graphically represented with a system circuit diagram. In addition, a system circuit diagram displays the electrical connections between the primary devices.

An example of a system circuit diagram 20 designed as a single-line representation is shown in FIG. 2. References made in the following description to a component depiction of a primary component should be understood as the graphical representation of the respective primary component. The system circuit diagram 20 in FIG. 2 shows two component depictions of busbars 21a and 21b denoted by “BB”, to which a first feeder 22a and a second feeder 22b are connected. The feeders 22a and 22b are meant to belong to a common substation in the electrical power grid. Each feeder includes component depictions of circuit breakers 23, a respective power switch 24, current transformers 25 or voltage transformers 26, and a respective cable outlet. In addition to the respective component depictions, short descriptions are respectively depicted, which specify the respective primary component represented by the component depiction according to a notation that is typical in the energy automation field. Thus, “QB” denotes a circuit breaker, and “QA” denotes a power switch. “BE” stands for a current or voltage transformer, while “WB” denotes a cable outlet. Some additional information about the primary components is shown. For example, FIG. 2 shows measurement ranges or transformation ratios for the current or voltage transformers.

The representation according to FIG. 2 shows only two comparatively simple matching feeders in order to simplify the explanation. Within the scope of the invention, system circuit diagrams of any level of complexity and having more or fewer components can of course be used. Likewise, a system circuit diagram can also have primary components other than the ones shown in the system circuit diagram 20 (for example, transformers, grounding switches).

For example, the generation of a system circuit diagram can be performed manually by a user of the configuration computer by means of a graphical editor. However, using an existing system definition file, such as an SSD (system specification description) according to the IEC 61850 standard, to create a system circuit diagram is particularly easy and unsusceptible to errors. In doing this, the topology of the substation described in the system definition file using a description language (for example, SCL or “substation configuration language” according to IEC 61850) is converted into a graphical representation having component depictions and the corresponding connections. Since no manual steps are required for this conversion, it is highly unsusceptible to conversion errors. In FIG. 1, the conversion of a system definition file into a system circuit diagram is depicted with an optional step 11.

Comparatively large, complex system circuit diagrams provided with detailed information, such as the system circuit diagram 20 according to FIG. 2, are highly suitable for representation on a display device of a configuration computer, which typically has a screen with a relatively large display surface and high resolution. However, such a system circuit diagram is not well suited for being displayed on a comparatively small display device of an energy automation device that has low resolution. Therefore, the system circuit diagram must be optimized to be displayed on a display device of an energy automation device. The steps required to do this are described below.

First, a selection made by the user of the configuration computer of a portion of the system circuit diagram is identified by the configuration computer in an additional step 12. Such a selection can be made, for example, by stretching a frame around the elements in the system circuit diagram to be selected. In FIG. 2, an exemplary frame 29 is shown, with which a user of the configuration computer has selected the second feeder 22b of the system circuit diagram 20.

In an additional step 13, the selected portion of the system circuit diagram 20 is then converted into a display configuration file. The display configuration file comprises instructions that can be read and converted by an energy automation device for creating a display on a display device of the energy automation device. The display configuration file can be a text file, an image file, or a combination of both types, and is designed such that an energy automation device is able to create a suitable display for its display device by interpreting the display configuration file. In particular, the technical means of the display device of the energy automation device that are reduced in comparison to a computer monitor (smaller display surface and/or lower resolution) are taken into account.

In order to convert the system circuit diagram into a display configuration file, the steps explained below are carried out, which are not depicted individually in FIG. 1. For this purpose, the configuration computer identifies the connections existing between the component depictions located in the selection area. According to the connections that are identified, connection information is created that describes the connections between the component depictions. This can be done graphically or in the form of a text-based description. In addition, simplified component depictions are associated with the component depictions located in the selection area.

The simplified component depictions have the same meaning with respect to content as the component depictions, but have a depiction that is graphically simpler, so that they can be displayed by means of the display device of the energy automation device.

Such an association of simplified components to the components of the system circuit diagram can be made, for example, using a library comprising a catalog of possible simplified component depictions that is stored on the configuration computer. For this purpose, a “type” is first assigned to each component depiction of the system circuit diagram, which describes the type of component depiction (for example, the “circuit breaker” type for the component depictions 23 of the system circuit diagram 20 of FIG. 2, and the “current transformer” type for the component depictions 25). A corresponding simplified component depiction is associated with each of these types of component depictions in the library of the configuration computer. Such a simplified component depiction can be, for example, a symbol or a representation of the component depiction of the system circuit diagram that is less detailed. Thus, for on-site operation directly on the energy automation device, unimportant details are automatically removed (for example, the depiction of current and voltage transformers is greatly simplified, since only their position is important for being displayed on the energy automation device, but not their particular design).

The simplified component depictions and the connection information are stored as a display configuration file in an (internal or external) storage device of the configuration computer. It is also ensured that the relative positions of the component depictions of the system circuit diagram also flow together with regard to the positioning of the simplified component depictions of the display configuration file (for example, current transformers are arranged above the voltage transformer). If component depictions have been rotated or mirrored in the system circuit diagram, this can be also taken into account in an embodiment of the method when creating the simplified component depictions in the display configuration file. Furthermore, it is optionally possible to add the labels of the component depictions in the system circuit diagram (for example, “QB2.1”, “BE2.2”) to the display configuration file in order to display them next to the corresponding simplified component depictions. Portions of labels that are unimportant for on-site operation, such as the specification of the measurement ranges or the conversion ratio of the current or voltage transformers, can be completely omitted.

In addition, it is optionally possible to provide that display device information that is stored on the configuration computer as being associated with the display device in question and which specifies at least the size of the display device (that is, the display surface) and/or its resolution, is used for adapting the display configuration file to the display device of the energy automation device to be used for the display. In order to adapt the display configuration file, it is then possible to provide that the size of the simplified component depictions is optimized to the display in the display device of the energy automation device, and that the spaces between the simplified component depictions are adapted such that the limited display surface of the display device of the energy automation device is utilized optimally.

In addition, it is optionally possible to provide that automatic detection occurs if the entire image that is defined by the display configuration file does not fit onto the display surface of the display device of the energy automation device, resulting in the display being spread over multiple switchable pages of the display device.

The display configuration file that is created in this way is stored in the storage device of the energy automation device. The display configuration file can be stored separately or can form a component of a parameter set that additionally contains other configuration parameters that specify the behavior of the energy automation device during its operation.

Steps 10 to 13 (FIG. 1) take place in the configuration computer, as is indicated by a dashed/dotted frame in FIG. 1.

Consequently, the display configuration file (possibly as a component of the parameter set) can be transmitted to the corresponding energy automation device via a communication connection existing between the configuration computer and the energy automation device or by means of a data storage device, as indicated by a dashed arrow 14. A data processing device of the energy automation device reads in the display configuration file and interprets it in such a way that the display specified by the display configuration file is depicted in the display device of the energy automation device in a following step 15.

In FIG. 3, an exemplary representation 30 from the selection area of the system circuit diagram according to FIG. 2 is depicted on the display device of the energy automation device as specified by the display configuration file. As can be seen, the representation 30 indicates a display corresponding to the second feeder 22b selected in FIG. 2 with regard to content, which, however, has simplified component depictions of the various primary devices. Thus, for example, the simplified component depictions 31 were created from the component depictions 25 for the current transformers.

According to another embodiment, it can furthermore be provided that the system circuit diagram has “interactive elements”, that is, component depictions of primary devices of the electrical power grid, which can assume different states (for example, in the case of a switch: open, closed). Corresponding state information can be associated with such component depictions that specifies the primary device in question and the operating states that it can assume. When converting to the display configuration file, it is thus possible to create and store different versions of simplified component depictions for such primary devices, that is, a separate simplified component depiction for each possible operating state (for example, for a switch, a depiction with an open current path and one with a closed current path).

When interpreting the display configuration file in the energy automation device, it is thus possible to link the version of the simplified component depiction to a state of the real primary components detected by the energy automation device, so that the respective operating state of the primary device is displayed by selecting the matching version of the simplified component depiction.

In the way described, it is possible to configure an energy automation device easily and reliably with respect to the display that it should depict, without the need for a complicated manual display generation process, as is typical today.

1-10. (canceled)

11. A method for configuring an energy automation device, which comprises the steps of:
generating a system circuit diagram of a substation of an electrical power grid using a configuration computer, the system circuit diagram configured to be displayed by a display device of the configuration computer and containing component depictions that are graphical representations of primary devices of the substation, and the system circuit diagram containing connections between the component depictions that are graphical representations of electrical links between the primary devices;
detecting a selection of a portion of the system circuit diagram made by a user of the configuration computer;
converting a selected portion of the system circuit diagram into a display configuration file that is suitable for a display device of the energy automation device, the converting step including:
identifying the connections existing between the component depictions contained in the selected portion via the configuration computer and creating connection information that specifies the connections between the component depictions;
associating simplified component depictions with the component depictions contained in the selected portion via the configuration computer, which are suitable for being displayed on the display device of the energy automation device; and
storing the simplified component depictions and the connection information as a display configuration file in a storage device of the configuration computer.

12. The method according to claim 11, which further comprises storing the display configuration file via the configuration computer as part of a parameter set containing configuration parameters that are created by the configuration computer, which are used to determine a behavior of the energy automation device during operation of the energy automation device.

13. The method according to claim 11, which further comprises generating the system circuit diagram by means of the configuration computer using a system definition file which specifies a description of a topology of the substation of the electrical power grid.

14. The method according to claim 11, wherein:
at least some of the component depictions contained in the system circuit diagram are associated with the primary devices of the electrical power grid that can assume at least two different operating states; and
state information is associated with a corresponding one of the component depictions that specifies a respective primary device represented by the one component depiction and various possible operating states of the respective primary device.

15. The method according to claim 14, which further comprises creating a simplified component depiction and entering the simplified component depiction into the display configuration file to create the display configuration file by the configuration computer with an aid of the state information for each possible state of the respective primary device that is associated with the component depictions.

16. The method according to claim 15, wherein:
the configuration computer contains a library for associating the simplified component depictions with the component depictions, in which the simplified component depictions are respectively associated with different types of the component depictions; and
the configuration computer identifies a type of the respective component depiction and takes the corresponding simplified component depiction from the library.

17. The method according to claim 14, which further comprises:
storing display device information in the storage device of the configuration computer, which contains specifications of at least one size and/or one resolution of the display device of the energy automation device; and
creating the display configuration file via the configuration computer such that the display configuration file is suitable for being displayed on the display device, taking into account the display device information.

18. The method according to claim 17, which further comprises adjusting at least one of a size of the simplified component depictions or spaces between the simplified component depictions when creating the display configuration file, taking into account the display device information.

19. The method according to claim 17, which further comprises transferring the display configuration file to the energy automation device and the display configuration file being interpreted by a data processing device of the energy automation device such that the data processing device creates a graphical display on the display device of the energy automation device by means of the display configuration file that displays the simplified component depictions and the connections existing between them.

20. The method according to claim 13, wherein the system definition file is an SSD file in accordance with the IEC 61850 standard.

21. A configuration computer, comprising:
a storage device;
a display device; and
a data processing device for configuring an energy automation device, said data processing device programmed to:
generate a system circuit diagram of a substation of an electrical power grid, the system circuit diagram configured to be displayed by said display device and contains component depictions that are graphical representations of primary devices of the substation, and the system circuit diagram contains connections between the component depictions that are graphical representations of electrical links between the primary devices;
detect a selection of a portion of the system circuit diagram made by a user;
convert a selected portion of the system circuit diagram into a display configuration file that is suitable for a display device of the energy automation device, the convert step including:
identifying the connections existing between the component depictions contained in the selected portion via the configuration computer and creating connection information that specifies the connections between the component depictions;
associate simplified component depictions with the component depictions contained in the selected portion via the configuration computer, which are suitable for being displayed on the display device of the energy automation device; and
store the corresponding simplified component depictions and the connection information as a display configuration file in said storage device.
